(19) United States
(12) Patent Application Publication
(10) Pub. No.: US 2016/0180261 A1
(43) Pub. Date: Jun. 23, 2016

(54) SYSTEM AND METHOD OF CREATING A DYNAMIC PARKING SPOT AND A SYSTEM AND METHOD OF CREATING A DYNAMIC PARKING ZONE\REGION

(71) Applicant: Sparkcity.com Ltd., Tel Aviv (IL)

(72) Inventors: Itamar Rosen, Tel Aviv (IL); Elimelech Weissberg, Kfar Chabad (IL)

(73) Assignee: Sparkcity.com Ltd., Tel Aviv (IL)

(21) Appl. No.: 15/058,245

(22) Filed: Mar. 2, 2016

Related U.S. Application Data
(63) Continuation-in-part of application No. PCT/IB2015/056509, filed on Aug. 27, 2015.
Application No. PCT/IB2015/056509 is a continuation-in-part of application No. PCT/IB2015/056512, filed on Aug. 27, 2015.
(60) Provisional application No. 62/042,445, filed on Aug. 27, 2014.
(60) Provisional application No. 62/042,445, filed on Aug. 27, 2014.

(51) Int. Cl. G06Q 10/02

(52) U.S. Cl. CPC G06Q 10/02

(57) ABSTRACT

A method including: (a) transmitting a vehicle registration number from a parking reservation server to a vehicle registration database; (b) receiving vehicle dimensions at the parking reservation server in response to the transmitting; (c) calculating a parking spot size based on the vehicle dimensions; and (d) reserving an appropriately sized parking spot based on results of the calculating.

### CROSS-REFERENCE TO RELATED APPLICATIONS

This is a Continuation-in-Part of International Patent Application No. PCT/IB2015/056509, filed Aug. 27, 2015, which claims the benefit of U.S. Provisional Patent Application No. 62/042,445, filed Aug. 27, 2014. This is also a Continuation-in-Part of International Patent Application No. PCT/IB2015/056512, filed Aug. 27, 2015, which claims the benefit of U.S. Provisional Patent Application No. 62/042,445, filed Aug. 27, 2014. All of the foregoing applications are incorporated by reference in their entirety herein.

### FIELD OF THE INVENTION

The invention is in the field of parking systems.

### BACKGROUND OF THE INVENTION

Among problems faced by local government today is a shortage of available parking spots. This is caused by a finite total area of often valuable real estate in city centers set aside for parking, as well as an inefficient use of this resource. When parking, both in marked or unmarked parking areas, many drivers park so as to occupy more than a single spot, and drivers of large vehicles are often unable to find parking of suitable size.

As a result, an individual driver may have difficulty finding parking, thereby wasting precious time and money.

Traffic congestion, air pollution and a lack of control of urban parking facilities are just some of the problems faced by municipalities in managing the urban environment, together with the accompanying economic burden.

While attempts have been made to combat these problems, they generally involve infrastructure changes such as the construction of multi-floor parking garages. Not only do such solutions require significant capital investment, but they are also impractical for installation in the sphere of on-street parking.

### SUMMARY OF THE INVENTION

Applicant has identified key components in providing a holistic solution to known parking problems faced both by drivers and by regional authorities such as municipalities and venue managers.

Methods and systems according to embodiments of the invention provide a solution to inefficient parking (e.g., a single vehicle parked so as to occupy more than a single parking spot), by increasing the efficiency of usage of existing parking resources. This effectively increases the parking capacity of the city as well as assists an individual driver to park.

A broad aspect of the invention relates to traffic control. More specifically various exemplary embodiments of the invention relate to parking reservation systems which assign parking spots to users based on availability. In some exemplary embodiments of the invention, users order parking spots using a user client device. According to various exemplary embodiments of the invention the user client devices are onboard computers (whether in a standard or driverless vehicle), smartphones, dedicated navigation devices (for example, a stand-alone GPS device) and/or tablet devices and/or laptop computers and/or wearable devices and/or desktop computers and/or 2G phones and/or specially equipped parking kiosks and/or and conventional phones (for example, operating through the Public Switched Telephone Network). Alternatively or additionally, in some embodiments parking docents carrying a user client device are deployed in order to assist drivers that do not have a user client device.

One aspect of some embodiments of the invention relates to assigning a correctly or appropriately sized individual parking spot for each incoming parking request. Designated parking areas in a region may be divided into subunits (“parking subunits”). In some embodiments a subunit is a conventional parking spot. In some embodiments the correctly sized individual parking spot is created by assembling two or more contiguous subunits. Alternatively or additionally, a reservation server considers vehicle dimensions associated with a vehicle registration number and/or additional size requirements requested by a system user. According to various exemplary embodiments of the invention the additional size requirements are communicated as part of the parking request and/or provided as part of a user profile.

Another aspect of some embodiments of the invention relates to a GUI on a user client device which facilitates communication of additional size requirements from the system user to the reservation server.

It will be appreciated that the various aspects described above relate to solution of technical problems associated with traffic congestion resulting from cars searching for parking spots.

Alternatively or additionally, it will be appreciated that the various aspects described above relate to solution of technical problems related to inefficient use of available parking spots.

Alternatively or additionally, it will be appreciated that the various aspects described above relate to solution of technical problems related to appropriate allocation of spots for special purposes (for example, deliveries).

Alternatively or additionally, it will be appreciated that the various aspects described above relate to solution of technical problems related to sign deployment and maintenance.

Alternatively or additionally, it will be appreciated that the various aspects described above relate to solution of technical problems related to changes in parking rules, for example, for special events.

In some exemplary embodiments of the invention there is provided a method including: transmitting a vehicle registration number from a parking reservation server to a vehicle registration database; receiving vehicle dimensions at the parking reservation server in response to the transmitting; calculating a parking spot size based on the vehicle dimensions; and reserving an appropriately sized parking spot based on results of the calculating. In some embodiments the method includes receiving at the parking reservation server additional size requirements and employing the additional size requirements in the calculating. Alternatively or additionally in some embodiments the method includes accessing reservation history for the vehicle registration number; and transmitting a query concerning additional size requirements to a user client device if a recent reservation from the same vehicle registration number included additional size requirements. Alternatively or additionally in some embodiments the method includes assembling two or more contiguous spots to create the appropriately sized parking spot.

In some exemplary embodiments of the invention there is provided a method including storing a list of parking subunits at a parking reservation server, each parking subunit associated with a unique identifier (UID) and location coordinates; receiving a parking reservation request including a vehicle registration number at the server from a user client device; ascertaining a size of the vehicle from the vehicle registration number; assembling a parking spot sized for the vehicle from two or more contiguous parking subunits; and transmitting location coordinates of the parking spot sized for the vehicle to the user client device as part of a reservation confirmation. In some embodiments the method includes associating the location coordinates of the parking spot sized for the vehicle with instructions to launch a navigation program on the user client device. Alternatively or additionally in some embodiments of the method, all of the parking subunits are same sized. Alternatively or additionally in some embodiments of the method, the parking subunits include at parking subunits that are differently sized.

In some exemplary embodiments of the invention there is provided a method including transmitting a parking request including a vehicle registration number and a destination to a reservation server from a user client device; receiving at the user client device a response including a map of an area in proximity to the destination with available parking subunits indicated; and a rectangle representing the vehicle defined by the registration number according to a scale of the map; and positioning the rectangle over two or more contiguous available subunits and entering a confirm command to reserve the two or more contiguous subunits. Alternatively or additionally in some embodiments of the method, the subunits are part of a parallel parking arrangement. Alternatively or additionally in some embodiments of the method, the subunits are part of a non-parallel parking arrangement. Alternatively or additionally in some embodiments, the method includes increasing a length and/or width of the rectangle to cover additional subunits.

In some exemplary embodiments of the invention there is provided a system including:

parcels of land each having a unique identifier; a database of said parcels of land; and a processor to calculate a parking spot using said parcels of land.

Unless otherwise defined, all technical terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

### GLOSSARY

For purposes of this specification and the accompanying claims the term “Region” indicates any geographical area having any or all types of parking facilities. “City” is used interchangeably with “region” unless specified otherwise.

For purposes of this specification and the accompanying claims, unless specified otherwise, the term “parking spot” or “spot” includes, for example, on-street, off-street, parking lots, garages (for example, multi-story parking towers and/or underground garages).

For purposes of this specification and the accompanying claims, unless specified otherwise, the term “venue” indicates a destination which attracts a large number of vehicles carrying occupants that share a common purpose. Examples of venues include football stadia, amusement parks, transportation hubs such as, for example, airports and train stations, and shopping malls.

For purposes of this specification and the accompanying claims, unless specified otherwise, the term “vehicle attribute” indicates either one or both technical data of the vehicle and legal status.

“Technical data” includes, but is not limited to physical dimensions (length, width and height), and engine type (powered by gasoline, hydrogen; liquid propane or electricity).

“Legal status” includes, but is not limited to, private, resident (for example, of a specific region or a specific parking zone defined within that region) emergency (for example, fire truck or ambulance), law enforcement, government (for example, municipal maintenance trucks, postal delivery vehicles), security, diplomatic, delivery, utility (for example, phone company or electric company).

For purposes of this specification and the accompanying claims the term “vehicle” indicates any wheeled conveyance used for on or off road transportation, provided that the specified vehicle is susceptible of being uniquely identified by listing in a database. This definition includes, but is not limited to, automobiles, motorcycles, bicycles, tricycles, motorbikes/scooters, buses, trucks, emergency vehicles, security vehicles, industrial vehicles and public transportation vehicles.

For purposes of this specification and the accompanying claims the terms “driver” and “user” are used interchangeably to mean a vehicle operator or vehicle passenger or other individual interacting with the system for the purpose of reserving a parking spot for a specified vehicle.

For purposes of this specification and the accompanying claims terms such as “processing,” “computing,” “calculating,” “determining,” “analyzing” or the like, refer exclusively to the action and/or processes of a computer, computing system, client/server system, or similar electronic computing device that manipulates and/or transforms data. In some embodiments these verbs are indicative of a transformation of abstract data into a concrete representation of information that has utility outside the machine on which it resides.

For purposes of this specification and the accompanying claims the terms “transmitting” and “receiving”, or their conjugates, indicate network data transfer.

For purposes of this specification and the accompanying claims “database” is represented by the acronym DB.

For purposes of this specification and the accompanying claims “Command and Control Center” is represented by the acronym CCC.

For purposes of this specification and the accompanying claims the acronym “UI” indicates user interface and the acronym “GUI” indicates graphical user interface.

For purposes of this specification and the accompanying claims the acronym “UID” indicates unique identifier.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed device, system or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system according to embodiments of the invention involves performing or completing selected tasks or steps manually, automatically, or a combination thereof. Moreover, according to actual instrumentation and equipment of exemplary embodiments of methods, apparatus and systems of the invention, several selected steps could be implemented by hardware or by software on any operating system of any firmware or a combination thereof. for example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The accompanying figures are:

FIG. 1 is a schematic representation of a parking system according to some embodiments of the invention;

FIG. 2a is a schematic representation of an exemplary graphic user interface for selecting a specific parking spot from a list offered by a reservation management server, displayed on a user client device;

FIG. 2b is a schematic representation of an exemplary graphic user interface for confirming arrival at specific parking spot interface assigned by a reservation management server displayed on a user client device;

FIG. 2c is a schematic representation of an exemplary graphic user interface for confirming departure from a specific parking spot assigned by a reservation management server displayed on a user client device;

FIG. 3. is a simplified flow diagram of a method according to some exemplary embodiments of the invention;

FIG. 4. is a simplified flow diagram of a method according to some exemplary embodiments of the invention;

FIG. 5. is a simplified flow diagram of a method according to some exemplary embodiments of the invention; and

FIG. 6 is a table illustrating an exemplary rule application scheme according to some embodiments of the invention;

FIG. 7a is a schematic representation of differently sized parking spots resulting from practice of a method according to some exemplary embodiments of the invention;

FIG. 7b depicts a GUI according to some exemplary embodiments of the invention; and

FIG. 7c depicts a GUI according to some exemplary embodiments of the invention;

FIG. 8a is a schematic representation of a system according to some exemplary embodiments of the invention;

FIG. 8b is a schematic representation of a system according to some exemplary embodiments of the invention;

FIG. 9 is a simplified flow diagram of a method according to some exemplary embodiments of the invention; and

FIG. 10 is a simplified flow diagram of a method according to some exemplary embodiments of the invention.

### DETAILED DESCRIPTION OF EMBODIMENTS

Embodiments of the invention relate to parking systems, methods and devices.

Specifically, some embodiments of the invention are used to assign a specific vehicle to a specific parking spot. In some embodiments the assignment is for a predetermined amount of time.

Alternatively or additionally, some embodiments of the invention are used to join two or more adjacent parking subunits to create a spot for a single vehicle (for example, a standard car, oversized or requiring extra clearance for a lift).

Alternatively or additionally, some embodiments of the invention are used to manage what were previously considered as separate parking resources (e.g., on street spots and/or off street lots or garages and/or individual privately owned-spots) as an integrated parking facility.

Alternatively or additionally, some embodiments of the invention are used to change parking rules from a central command and control center (CCC) easily and conveniently.

Alternatively or additionally, some embodiments of the invention are used to provide usage statistics to the CCC according to selected areas. According to various exemplary embodiments of the invention the statistics are presented as a function of time and/or price.

The principles and operation of systems and/or methods and/or devices according to exemplary embodiments of the invention may be better understood with reference to the drawings and accompanying descriptions.

Before describing at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of exemplification and should not be regarded as limiting.

System Overview

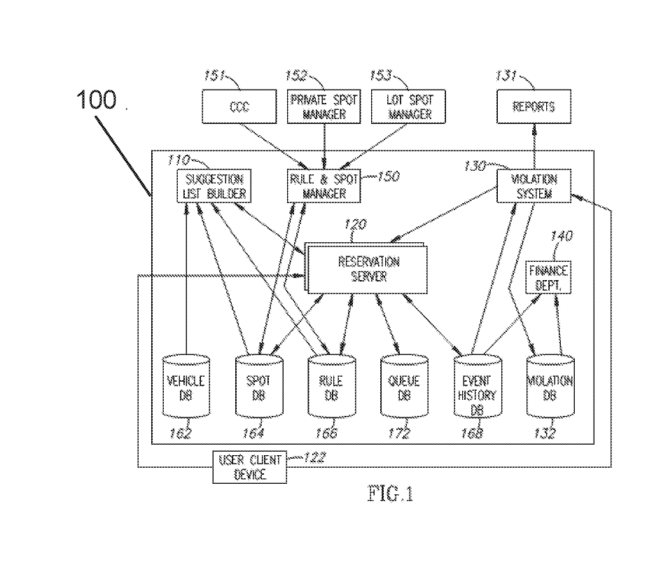

FIG. 1 is a schematic representation of a computerized parking system illustrating the context in which various embodiments operate, indicated generally as system 100. Sub-systems and related methods discussed in greater detail below may be easier to understand when considered in the context of system 100 as described here.

Referring now to FIG. 1, depicted exemplary system 100 operates a reservation server 120 which receives inputs from user client devices 122. A single user client device 122 is depicted for clarity although a much larger number will be present in actuality.

One main function of the system is to receive parking requests from user client devices 122. In one embodiment, the request entered by a user includes a vehicle registration number and an indication of a destination. Server 120 responds to each request by providing a reservation for a specific vehicle (e.g., identified by vehicle registration number) to a specific parking spot based upon a parking request from the user. In order to support this function, many embodiments of system 100 aid the operator of user client device 122 in locating and/or identifying the specific parking spot associated with their reservation.

Another main function of system 100 is to contribute to efficient enforcement of parking violations. One way that system 100 makes this contribution is by permitting user client devices 122 to report parking violations to a violation system 130.

According to various exemplary embodiments of the invention reservation server 120 communicates with one or more information resources to procure information needed to process an incoming parking reservation request from user client 122.

Exemplary databases (DBs) in system 100 are:

Vehicle DB 162, which stores vehicle attributes (as defined in Glossary hereinabove) in association with a vehicle registration number. In some embodiments at least a portion of the information in vehicle DB 162 is available from a governmental licensing authority (for example, department of motor vehicles, department of public safety or ministry of transportation). In some embodiments system 100 communicates with an external governmental DB (not depicted) during processing of each incoming reservation request. In some embodiments system 100 mirrors the external governmental DB. In some embodiments, mirroring contributes to processing speed of each incoming reservation request. Alternatively or additionally, system 100 provides supplemental information to DB 162 (for example, legal attributes associated with a vehicle) and/or an icon depicting the vehicle.

Parking spot DB 164 which stores information regarding the location (i.e. location coordinates), size and current status of parking subunits. Each parking spot (which may consist of several parking subunits) is administered by the system 100. Information regarding the location, size and current status of parking spots is also be stored in spot DB 164.

In some exemplary embodiments of the invention, each parking subunit and/or specific spot has a unique identifier (UID). In some embodiments the UID is visible to a user of the system when they park their car (for example, painted on the pavement or on a wall or a sign adjacent to the subunit(s) or spot). In some embodiments spot DB 164 also stores status for future time points (for example. if advance reservations are accepted and/or if the current use is subject to a time limitation). Typically spot DB 164 assigns a status of “available” or “not available” for each individual parking subunit as a function of time. The status “available” for a subunit indicates that it is not occupied and not reserved and not precluded from use by any rule. The status “not available” indicates that the spot is either occupied or reserved or precluded from use by a rule or “uncertain”. In some cases a temporary “uncertain” status is applied to spots and/or parking subunits which are the subject of complaints or reports. The “uncertain” status will only be maintained until the actual status is investigated (e.g., by dispatching system personnel to inspect the parking spot). In some embodiments sub statuses are applied, such as “reserved”, “occupied”, “in violation”.

Rule DB 166, which stores parking rules for each individual spot administered by the system. According to various exemplary embodiments of the invention, rule changes are applied to individual spots and/or groups of spots by one or more parties. As a result, multiple rules apply to a given spot at any given moment in some embodiments. Alternatively or additionally, rules often have multiple attributes as described hereinbelow in the section entitled “Exemplary rule attributes”.

Queue DB 172, which stores incoming parking reservation requests that have not yet been transformed into reservations for a specific spot and/or reservations for a specific spot which have not yet been taken up by an assigned car parking in the assigned spot.

Event history DB 168, which stores “parking events” for a particular spot defined in terms of at least a vehicle registration number and a parking duration. In many embodiments details such as, for example, date, reservation time, time in, time out, specific parking spot and hourly rate are also stored. Periodically, events from event history DB 168 are sent from system 100 to finance department 140 for payment processing.

Violation history DB 132, which stores “violation events” defined in terms of at least a vehicle registration number and a specific spot. In many embodiments details such as, for example, date, time, infraction type (e.g., parked for 3 hours in a 2 hour spot or parked in a spot reserved for another vehicle) are stored. In some embodiments, evidence (e.g., a photograph of the infraction with a date/time stamp) is also stored in DB 132. Periodically, events from DB 132 are sent from system 100 to finance department 140 for payment processing.

In the depicted embodiment, reservation server 120 also communicates with suggestion list builder 110 to process at least some of the incoming parking reservation requests from user clients 122. Suggestion list builder 110, in turn, communicates with DBs 162, 164 and 166 to assemble a list of available spots in proximity to a destination defined in the request received from user client device 122 and suitable for the car defined by the vehicle registration number in the request.

Alternatively or additionally, in some embodiments reservation server 120 also communicates with violation system 130 and relays violation information to spot DB 164. According to various exemplary embodiments of the invention violation information includes discovery of an unauthorized vehicle in a specific spot and/or a report of removal by a law enforcement agency of an unauthorized vehicle from a specific spot. Both the discovery and the removal report result in a status change for the specific spot in question in DB 164. In some embodiments violation system 130 reports events which prevent the use of or access to a parking spot. Examples of such events include for example, a fallen tree or piles of snow resulting from plowing.

In some embodiments violation system 130 also issue reports 131 in the form of parking tickets.

In the depicted embodiment, system 100 includes a rule and spot manager 150 functioning to relay externally provided rules to spot DB 164. In the depicted embodiment externally supplied rules originate from a command and control center (CCC) 151 and/or from lot spot manager 153 and/or from private spot manager 152. Each of CCC 151, private spot manager 152 and lot spot manager 153 operate a rule input interface adapted to their specific needs. The rule input interface for CCC 151 is typically the most robust of the three. The rule input interface for CCC 151 handles the largest number of spots and deals with the largest number of possibilities. The rule input interface for lot spot manager 153 is typically intermediate in capacity. For example, the rule input interface for lot spot manager 153 deals primarily with rules applicable to a whole parking facility, or a whole floor within a parking facility in some cases. The rule input interface for private spot manager 152 typically has the least capacity. Private spot manager 152 deals with rules for a single spot.

Exemplary Single Parking Reservation Request

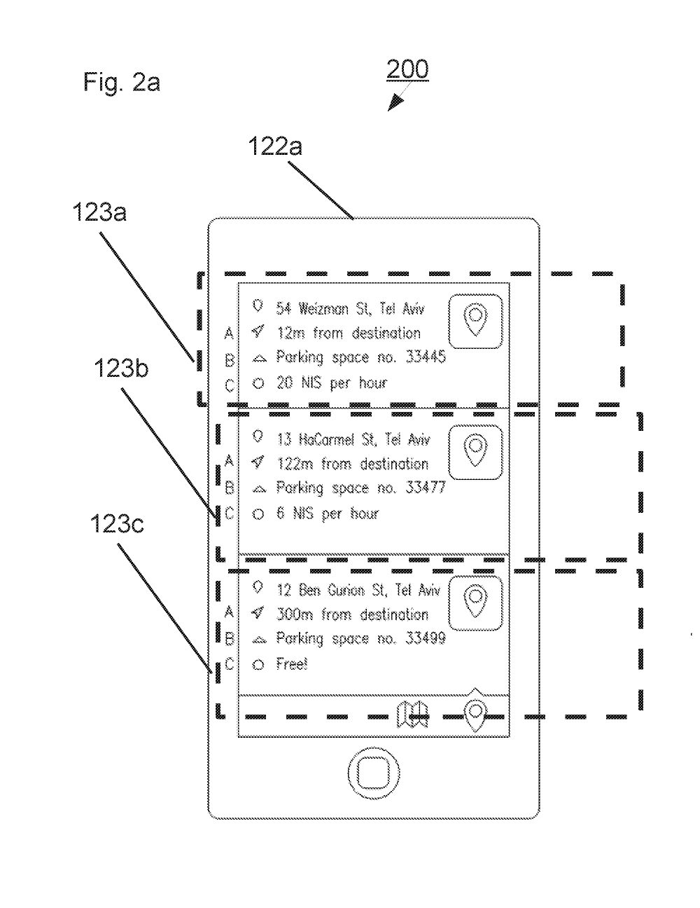

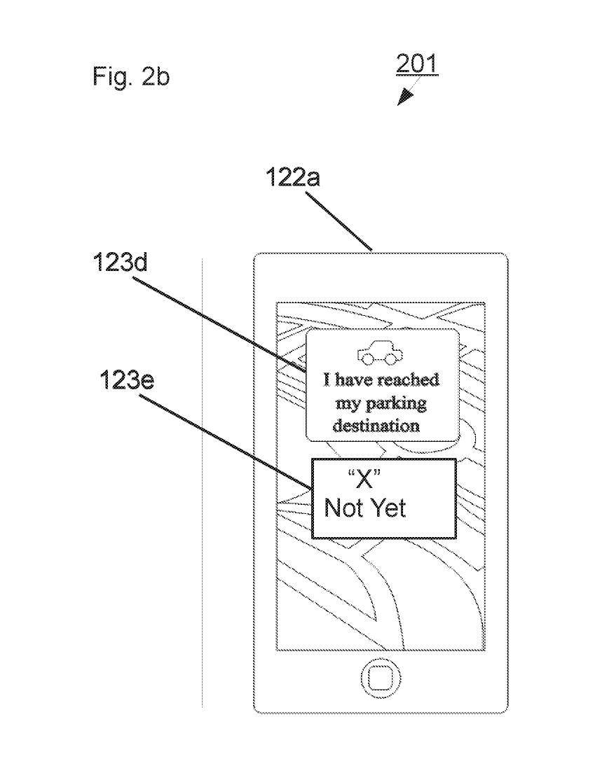

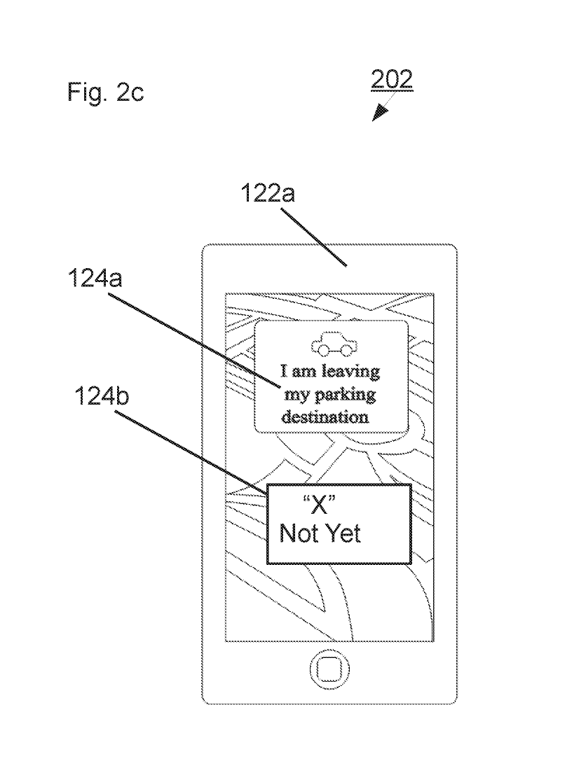

As an example of how system 100 works, the processing of a single reservation request, which defined 52 Weizmann St. in Tel Aviv as a destination, is described with respect to both the functionalities of system 100 (FIG. 1) and of a specific user client device 122a (FIGS. 2a-2c) in the form of a smart phone running a software application (“app” or “parking app”) that serves as a communication interface between system 100 and the display of device 122a. According to various exemplary embodiments of the invention, the vehicle registration number is either included in the request or is available to the system from a user profile established previously (For example, during installation of the app).

Reservation server 120 of system 100 (FIG. 1) receives the request and relays it to suggestion list builder 110. List builder 110 analyzes information in DBs 162, 164 and 166 and assembles a list of available parking spots that are relevant to the specific request. According to various exemplary embodiments of the invention relevance is analyzed either according to a user profile and/or according to rules programmed into list builder 110. The list of available parking spots is relayed to user client device 122a via reservation server 120.

FIG. 2a is a schematic representation, indicated generally as 200, of an exemplary user client device 122a displaying a user interface for selecting a specific parking spot from a list offered by reservation management server 120 after construction by list builder 110. In the depicted embodiment each of list items 123a, 123b and 123c includes a street address, a distance from the requested destination and an hourly rate. An operator of device 122a makes a selection by touching one of the items in the list or by issuing a voice command.

In some embodiments selection of a list item issues an instruction to a navigation app running on user client device 122a and the navigation app guides the operator of 122a to a specific parking spot using location coordinates associated with the item selected from the list (but typically not displayed on the screen).

FIG. 2b is a schematic representation, indicated generally as 201,

of user client device 122a displaying an exemplary interface for confirming arrival at a specific parking spot assigned by reservation management server 120 (FIG. 1) overlaid on the map of the navigation app. Since the navigation app is aware of current location and speed (for example, from a tracking component installed in device 122a), in some embodiments the navigation app displays a prompt 123d to confirm parking as the vehicle approaches the spot and/or slows down in proximity to the spot. The user confirms as described above for selection of a list item. In the depicted embodiment, a “do not confirm” icon 123e is also provided. Upon receipt of confirmation of parking at server 120, the server updates the sub-status of the specific spot and/or of the parking subunits comprising the spot in DB 164 from “reserved” to “occupied”.

FIG. 2c is a schematic representation, indicated generally as 202, of user client device 122a displaying an exemplary interface for confirming departure from a specific parking spot assigned by a reservation management server 120. Since the navigation app is aware of current location and speed (for example, from a tracking component installed in the device), the navigation app displays a prompt 124a to confirm exit from the parking spot as the vehicle departs from the spot and/or attains a velocity that indicates the operator of the device is not on foot (for example, 25 km/hr). The user of the device confirms as described above for selection of a list item. In the depicted embodiment a “do not confirm” icon 124b is also provided. Upon receipt of confirmation of exit from the parking spot at server 120, the server 120 updates the sub-status of the specific spot and/or the parking subunits comprising the spot) in DB 164 from “occupied” to “unoccupied” or “reserved” as appropriate.

This simplified example does not demonstrate the full range of capabilities of system 100.

First Exemplary Method

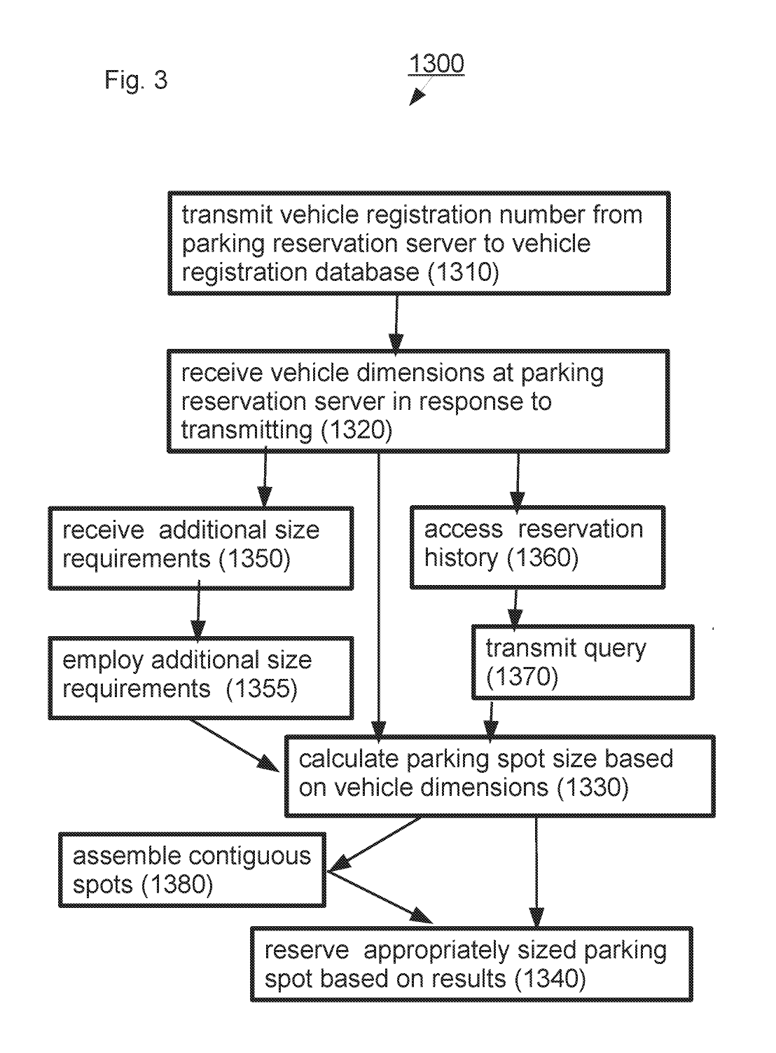

FIG. 3. is a simplified flow diagram of a method, indicated generally as 1300 for assigning appropriately sized parking spots to each vehicle in a computerized parking management system according to some exemplary embodiments of the invention.

Exemplary method 1300 includes transmitting 1310 a vehicle registration number from a parking reservation server 120 (FIG. 1) to a vehicle registration database 162 (for example, via list builder 110). In the depicted embodiment the method includes receiving 1320 vehicle dimensions at parking reservation server 120 from DB 162 in response to transmitting 1310 and calculating 1330 a parking spot size based on the vehicle dimensions.

In some embodiments, calculating 1330 is based upon vehicle length. Alternatively or additionally, in some embodiments calculating 1330 is based upon vehicle width. Alternatively or additionally, in some embodiments calculating 1330 is based upon vehicle height. Alternatively or additionally, in some embodiments calculating 1330 is based upon required side clearance and/or rear clearance (for example, for a vehicle with a lift for a wheelchair or freight.)

In the depicted embodiment once the correctly sized parking spot has been calculated, server 120 searches spot DB 164 to find an appropriately sized available spot and reserves 1340 the spot for the vehicle identification number.

According to various exemplary embodiments of the invention vehicle registration database 162 is either an existing external resource or a mirror DB. In some embodiments DB mirroring contributes to a reduction in request processing time. Alternatively or additionally, DB mirroring permits association of additional information with a vehicle registration number. In some embodiments additional information is incorporated by compiling user profiles which include vehicle registration numbers. In some embodiments method 1300 includes receiving 1350 at parking reservation server 120 additional size requirements and employing 1355 the additional size requirements in calculating 1330. Additional size requirements include, but are not limited to, requests relating to temporary physical changes in vehicle dimensions (for example, a trailer attached to a pick-up truck or a semi-truck cab that is parking without a trailer) and/or to user preferences (for example, I need one and a half car lengths to parallel park).

Alternatively or additionally, in some embodiments method 1300 includes accessing 1360 a reservation history for the vehicle registration number (for example, by reservation server 120 querying event history DB 168) and transmitting 1370 a query concerning additional size requirements if a recent reservation from the same vehicle registration number included additional size requirements, for example, in a family with several drivers, a driver that recently received their license requests extra space every time they park a car with a certain vehicle registration number because they lack confidence. Other drivers of the same vehicle request only what is required according to calculating 1330 based on actual dimensions. In such a case system 100 transmits 1370 queries concerning additional space requirements each time the vehicle is parked until a threshold number of consecutive parking reservations are made with a negative response to the query 1370. According to various exemplary embodiments of the invention the threshold number of events is 3, 5, 10, 15, 20 or 25 or intermediate or greater numbers. In some embodiments the query includes a “do not ask again” option which overrides the threshold. In some embodiments server 120 identifies a specific user client device 122 from which additional size requirement requests originate and transmits 1370 only to that user client device.

In some embodiments calculating 1330 results in assembling 1380 two or more contiguous spots and/or parking subunits to create the appropriately sized parking spot prior to reserving 1340. In such cases the reservation is for a spot created from the two or more contiguous spots and/or parking subunits. In some embodiments spot DB 164 stores parking subunits with dimensions that are too small for most vehicles to facilitate future assembly.

As known, each vehicle for which parking is requested by a user, has predetermined dimensions, as well as possible additional size requirements as described above. The step of calculating 1330 typically includes determining the dimensions of available spots based on one or more groups of contiguous available subunits stored in spot DB 164 and comparing the vehicle size requirements the determined dimensions of the available spots. Either a complete available spot or a portion thereof, depending on the number of subunits corresponding to the vehicle size requirements, is then be allocated to the vehicle, and will be associated with the vehicle registration number in spot DB 164. According to various exemplary embodiments of the invention defragmentation algorithms/functions are applied to obtain optimal division of the available on vehicle dimensions and other parameters.

In one embodiment calculating 1330 includes dividing available parking spots based on vehicle dimensions. In some embodiments additional parameters are also taken into account, such as the enlargement of a proposed parking spot for ease of access. A typical case in which ease of access is a factor is proximity to a crowded street, whereat the available area from parking is divided more precisely than a similar parking area at a less busy location, so as to provide more, smaller parking spots at the expense of fewer, larger spots. According to various exemplary embodiments of the invention defragmentation algorithms/functions are applied to obtain optimal division of the available on vehicle dimensions and other parameters.

Second Exemplary Method

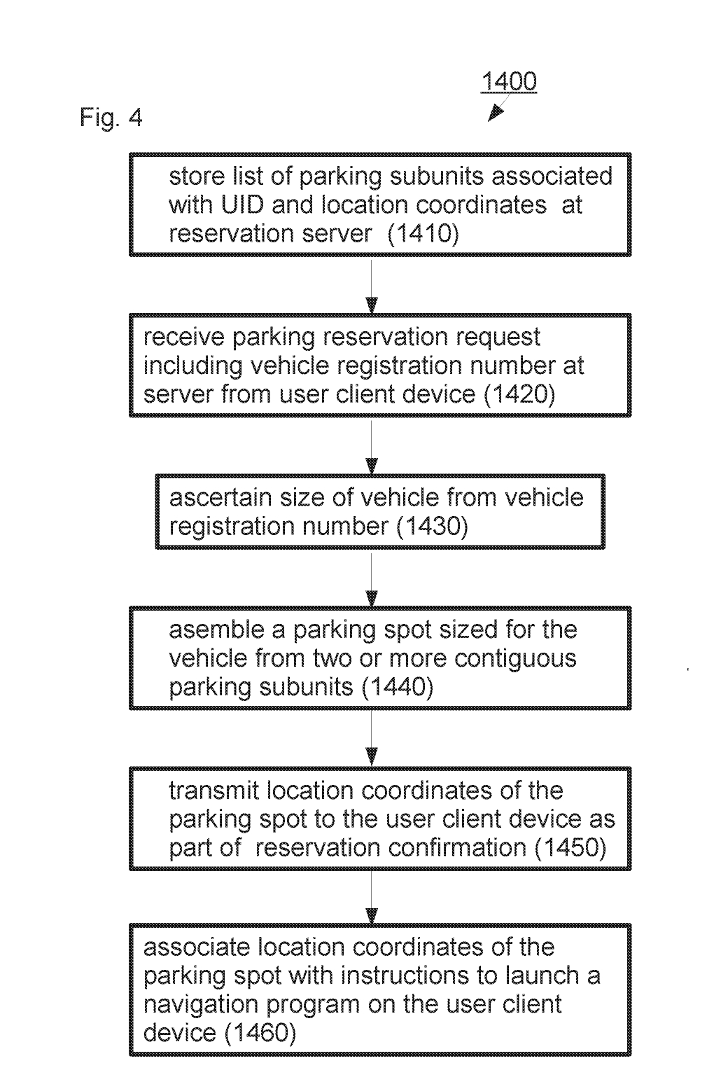

FIG. 4 is a simplified flow diagram of a method, indicated generally as 1400, for assembling an appropriately sized parking spot for each vehicle in a computerized parking management system according to some exemplary embodiments of the invention.

Depicted exemplary method 1400 includes storing 1410 a list of parking subunits by a parking reservation server (for example, 120 in FIG. 1) on a spot DB (for example, 164 in FIG. 1), each parking subunit associated with a unique identifier (UID) and location coordinates. Depicted exemplary method 1400 also includes receiving 1420 a parking reservation request including a vehicle registration number at the server from a user client device (for example, 122 in FIG. 1) and ascertaining 1430 a size or dimension of said vehicle from its vehicle registration number. According to various exemplary embodiments of the invention ascertaining 1430 includes transmitting a request for information to an external data resource (for example, Department of Motor Vehicles database) and/or transmitting a request for information to DB 162 (FIG. 1) and/or a machine implemented review of a user profile. Optionally, user profiles are stored in DB 162.

Depicted exemplary method 1400 also includes assembling 1440 a parking spot sized for the vehicle from two or more contiguous parking subunits and transmitting 1450 location coordinates of the parking spot sized for the vehicle to the user client device 122 (FIG. 1) as part of a reservation confirmation.

In some embodiments method 1400 includes associating 1460 the location coordinates of the parking spot sized for the vehicle with instructions to launch a navigation program on the user client device.

In some embodiments all of the parking subunits are same sized. In other exemplary embodiments of the invention, not all of the parking subunits are same sized.

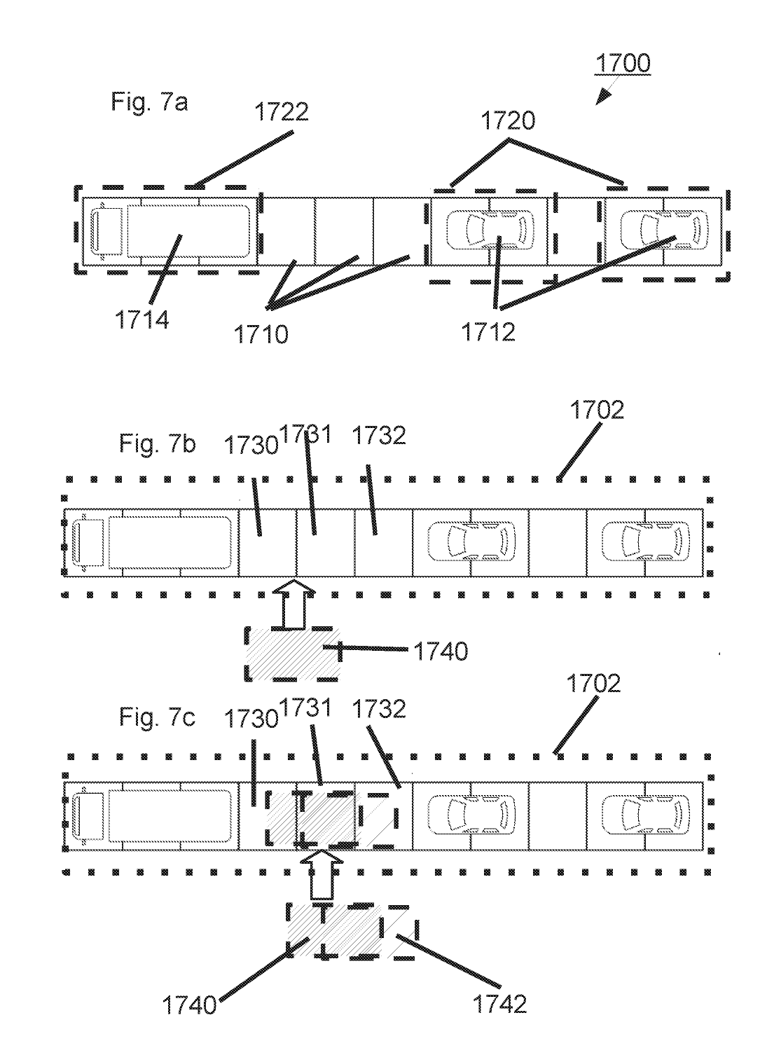

Reference is now made briefly to FIG. 7a which is a schematic representation, indicated generally as 1700, of differently-sized parking spots assembled from a requisite number of subunits 1710 to accommodate cars 1712 and a truck 1714. In the depicted embodiment the pavement is marked to indicate subunits 1710 which are too small to accommodate most vehicles. In response to parking reservation requests with vehicle registration numbers associated with cars 1712, there are seen to have been assembled 1440 by server 120 (FIG. 1) car-sized spots 1720 using two contiguous subunits 1710 to create each spot. In response to a parking reservation request with a vehicle registration number associated with a truck 1714, there is seen to have been assembled 1440 by server 120 a truck-sized spot 1722 using three contiguous subunits 1710.

Third Exemplary Method

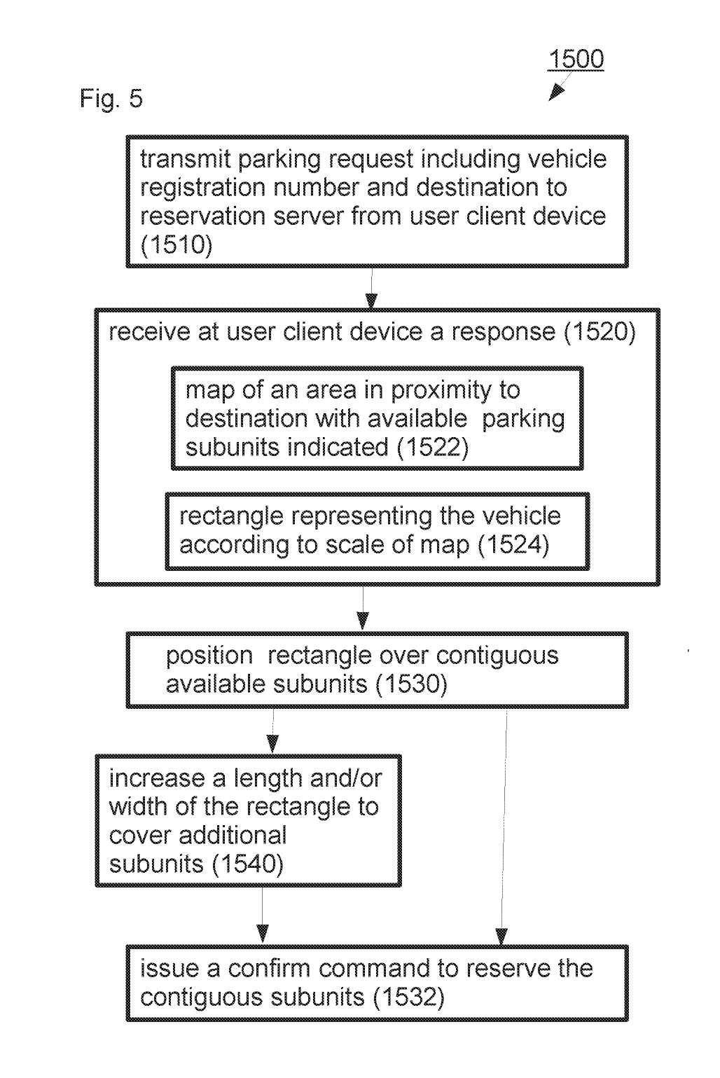

FIG. 5 is a simplified flow diagram of a method, indicated generally as 1500, for a user client assembly of parking subunits. In the depicted embodiment method 1500 includes transmitting 1510 a parking request including a vehicle registration number and a destination to a reservation server (for example, 120 in FIG. 1) from a user client device (for example, 122) and receiving 1520 a response at the user client device. In the depicted embodiment the response of 1520 includes a map 1522 of an area in proximity to the destination with available parking subunits indicated and a rectangle 1524 representing the vehicle by its registration number. The vehicle size is indicated by the rectangle size according to a scale of the provided map. The response serves as a GUI for assembly of two or more contiguous available subunits to create a correctly sized parking spot.

The GUI facilitates positioning 1530 the rectangle over two or more contiguous available subunits and issuing 1532 a confirm command to reserve the newly created correctly sized parking spot. Issuing 1532 of the confirm command is performed, for example, by double clicking on the rectangle while it is correctly positioned and/or using a voice command. According to various exemplary embodiments of the invention subunits are part of a parallel parking arrangement and/or are part of a non-parallel parking arrangement (for example angled or perpendicular).

For purposes of the description of the third exemplary method and the corresponding claims, the phrase “rectangle representing the vehicle defined by registration number” includes any rectangle or other shape having a similar length and/or width as the vehicle (scaled to map). This definition includes a line segment with a length corresponding to vehicle length or width.

FIG. 7b depicts a GUI exemplifying method 1500 according to some embodiments of the invention as described in the preceding paragraphs. In the drawing 1702 is a map of an area with available parking subunits indicated. Subunits which are unavailable are depicted as being occupied by vehicles. The only subunits in a contiguous array of two or more are 1730, 1731 and 1732. In the drawing rectangle 1740 represents the vehicle and the hollow arrow indicates positioning over subunits 1730 and 1731 (as opposed to 1731 and 1732).

In some embodiments the GUI is adapted for increasing 1540 (FIG. 5) a length and/or width of the rectangle to cover one or more additional subunits.

FIG. 7c depicts a GUI implementation of this optional feature on map 1702 as in FIG. 7b. In the figure rectangle 1740 is expanded by addition of area 1742. The hollow arrow indicates positioning over subunits 1730 and 1731 and 1732. As a result of the expansion of the rectangle, that is the only choice in this example.

Additional Exemplary System

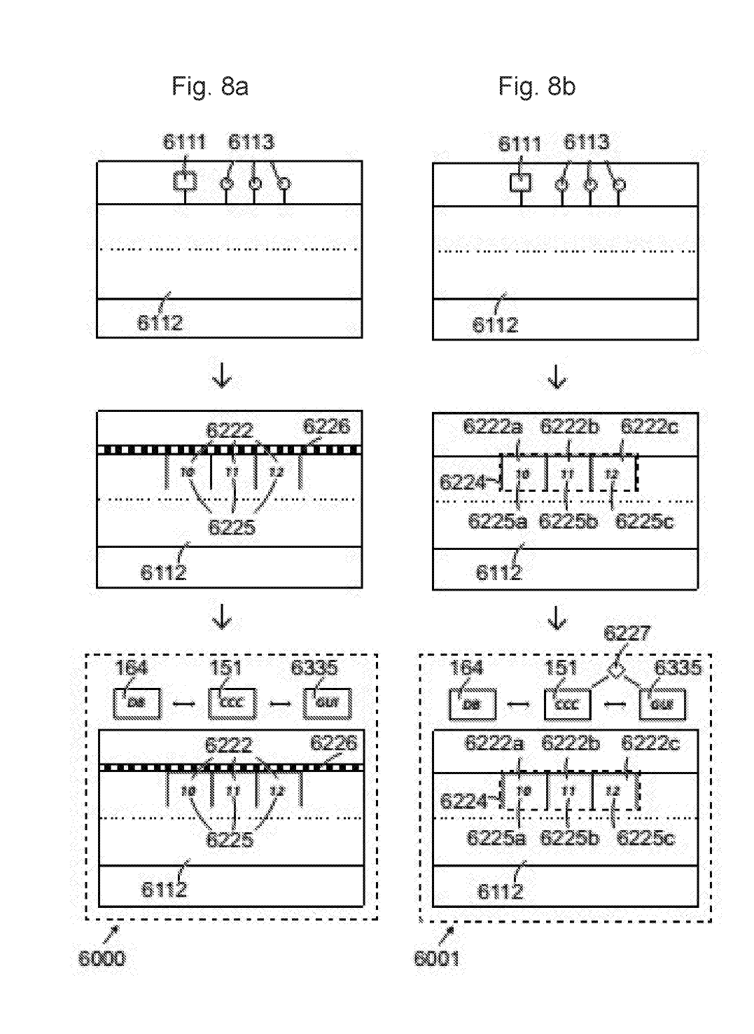

FIG. 8A schematically illustrates that current parking solutions for parking on street 6112 include the use of equipment such as signs 6111 depicting use rule (e.g., parking rules) for the street 6112 and parking meters 6113. In some embodiments of the invention currently used equipment is eliminated. Alternatively or additionally, in some embodiments a street such as street 6112 is divided into parcels of land such as subunits 6222, each parcel of land having a unique identifier 6225.

Depicted exemplary system 6000 includes a database (DB) such as spot DB 164 (FIG. 1) of parcels of land or subunits 6222. In some embodiments spot DB 164 includes at least the unique identifiers 6225. Alternatively or additionally, in some embodiments system 6000 includes a command and control center (CCC) 151 which applies at least one use rule to a subunit 6222 or to several subunits. For example, in some embodiments CCC 151 applies a payment parking rule to some or all of the subunits, or CCC 151 applies a handicap vehicle only rule to some of the subunits. According to various exemplary embodiments of the invention CCC 151 applies any other rule and/or rule type to one or more subunits 6222.

Alternatively or additionally, in some embodiments system 6000 includes a user interface. In some embodiments the UI is a GUI, for example GUI 6335. Depicted exemplary GUI 6335 displays a rule in relation to the parcel of land. In some embodiments GUI 6335 is available to a CCC 151 computer workstation. According to these embodiments, a user of the workstation sees the rules applied to each subunit. Current and/or past and/or future rules are displayed per subunit. In some embodiments GUI 6335 is available on a warden's user client device, in some embodiments the warden's user client device is in communication with the CCC 151. According to these embodiments, a warden sees the rules applied to any specific subunit. In yet another embodiment GUI 6335 is available on a user client device 122 (e.g., a driver's device or a kiosk running an application according to exemplary embodiments of the invention).

Alternatively or additionally, in some embodiments street 6222 is marked, e.g., by marking 6226, to advise drivers that the parcels of land 6112 are managed by CCC 151. In some embodiments other markings that are not necessarily on the street are used.

For example, CCC 151 communicates with spot DB 164 via rule and spot manager 150 to apply a rule on a subunit 6222. In some embodiments the rule is displayed on GUI 6335 at the CCC 151 or on GUIs of user client devices 122. According to various exemplary embodiments of the invention one or more rules to a subunit causes different subunits to be available for parking to different vehicles. For example, in some embodiments a driver using a method according to an embodiment of the invention is directed to a parking space (which may include one or more subunits) efficiently with no need for signs, meters or other equipment.

In one embodiment, which is schematically illustrated in FIG. 8B system 6001 includes a processor 6227 for calculating a parking spot using the parcels of land. Alternatively or additionally, in some embodiments processor 6227 communicates with DB 164 and/or CCC 151 and/or with GUI 6335 (for example a GUI on user end device 122a of FIG. 1). Alternatively or additionally, in some embodiments processor 6227 calculates a parking spot 6224 using subunits 6222a, 6222b and 6222c as basic units.

In some exemplary embodiments of the invention, subunits 6222a, 6222b and 6222c are of equal size and a parking spot 6224 includes one or more contiguous subunits. In other embodiments subunits 6222a, 6222b and 6222c are differently shaped and/or sized. Thus, in one example, a single parking spot 6224 includes several contiguous subunits and is associated with several unique identifiers (e.g., by all unique identifiers 6225a, 6225b and 6225c making up the parking spot 6224 or by the unique identifiers 6225a and 6225c marking the boarders of the parking spot 6224).

In some embodiments calculating a parking spot 6224 is done by using suitable algorithms as described herein. For example, calculating a parking spot 6224 is based at least on vehicle size. In one example, a parking spot calculated for a large vehicle (e.g., a truck) includes three contiguous parcels of land (e.g., 6222a, 6222b and 6222c) whereas a parking spot calculated for a small vehicle (e.g., motorcycle) includes only one parcel of land. Thus, when a request for parking of a large vehicle is accepted at reservation server 120 a different parking spot is calculated and displayed on GUI 6335 than when a request for parking a small vehicle is accepted at reservation server 120. For example, a GUI 6335 displaying a parking spot for a truck shows a parking spot identified as 6225a-6225c whereas a GUI 6335 displaying a parking spot for a motorcycle shows a parking spot identified as 6225a.

Exemplary User Client Devices

According to various exemplary embodiments of the invention a smartphone (e.g. using APPLE IOS or ANDROID OS), a tablet device, a wearable device (e.g. APPLE watch or ANDROID wear), a personal computer (e.g. laptop or desktop), an onboard computer in a vehicle, a 2G mobile phone, a conventional phone (operating through the public switched telephone network) and a kiosk serve as a user client device. According to various exemplary embodiments of the invention the onboard computer in a vehicle is selected from the group consisting of a portable device, a built in device in a standard (driver operated) car and a built in computer on an automatic (driverless car).

Different user client device types interface with the system in different ways.

For example, a smartphone or onboard computer interfaces with the system using software installed on the client device. Depending on the software design the system transmits information (for example, cues and/or options) to the client device for display on the screen of the client device and/or as audio output though a speaker of the client device. A user input responses to the device using a touchscreen and/or by voice activation. In some embodiments if no user input is received within a pre-set time period, the system proceeds according to a default selection (for example, the first item in a list).

Alternatively or additionally, in some embodiments a smartphone or 2G phone transmits an SMS to a designated telephone number which serves as a system interface. Successive exchanges of information are conducted via SMS according to these embodiments.

Alternatively or additionally, in some embodiments a tablet device or a personal computer (for example, laptop or desktop) serves as a user client device. According to these embodiments exchanges between the user client and the system of information are, for example, via an internet portal operated by the system.

Alternatively or additionally, in some embodiments a smartphone or 2G phone or a conventional telephone places a telephone call to a designated telephone number which serves as a system interface. According to these embodiments exchanges of information are via an IVR (integrated voice response) system and/or a call center.

In some embodiments a dedicated kiosk serves as a user client device for users of the system that do not have another device available to them and/or to supplement another user client device employed to complete a portion of the reservation process. For example, a user that used their home telephone to reserve a parking spot via an IVR interface uses a kiosk in proximity to their assigned spot to notify the system when they arrive and depart from their assigned parking spot.

In some embodiments a parking attendant operates a user client device for users that do not have a device of their own.

Alternatively or additionally, in some embodiments the system identifies a vehicle based upon a user client device. For example, in some embodiments a phone number is associated with vehicle registration number in a user profile (e.g. stored in vehicle DB 162; FIG. 1). In those embodiments where a smartphone serves as a user client device, the phone number of the user client is available even if an incoming reservation request is via data network, as opposed to in the form of a telephone call.

Vehicle Icons

In some embodiments, system 100 (FIG. 1) includes, or has access to, a database of vehicle icons. Icons are designed to convey information pertaining to general vehicle type and/or appearance (for example, car/truck/SUV) and/or specific vehicle type (for example, sedan/station wagon/coupe/hatchback) and/or manufacturer (for example, FORD, CHEVY, HONDA, MAZDA, TOYOTA) and/or model (for example, COROLLA, CAMRY) and/or model year (or sets of model years with distinctive design features) and/or other characterizing features, such as color or shape. According to various exemplary embodiments of the invention the icons are two dimensional or three dimensional. In some embodiments the icons are empty line drawings and are filled with an appropriate color prior to use. In other exemplary embodiments of the invention, each icon is stored as multiple copies in different colors. In some embodiments icons are stored in vehicle DB 162 as a portion of individual vehicle records or as a separate collection of information within the DB.

Generation of Location Mockups

In some embodiments, system 100 (FIG. 1) uses a UID and/or position coordinates of a specific parking spot to generate a visual representation of the spatial context of the parking spot. The visual representation, in digital format, is transmitted to a user client device 122. In some embodiments user client device 122 is destined to the specific spot (for example, a smartphone or onboard computer). In some embodiments the transmission of the visual representation is made as the relevant user client device approaches the spot. In some embodiments a single fixed angle picture serves as the visual representation. In other exemplary embodiments of the invention, the visual representation is a virtual reality file which changes as the user client device moves relative to the assigned parking spot.

In some embodiments building faces from external sources (for example, GOOGLE MAP™ street view) are added to the visual representation.

Exemplary View Switching

In some embodiments the view on a user client device switches to perspective or street view as the device approaches the destination and/or an assigned parking spot. According to various exemplary embodiments of the invention the switch occurs when a proximity threshold is crossed. According to various exemplary embodiments of the invention the proximity threshold is defined in terms of distance and/or estimated arrival time. Alternatively or additionally, in some embodiments reduction of vehicle speed below a speed threshold triggers a switch to perspective view/street view. In some embodiments this view switching indicates presentation of one or more additional views (for example, using a split screen or pop-up window). In some embodiments a single fixed angle picture is presented as the “switched view” (for example, in a pop-up window).

Exemplary Rule Attributes

According to various exemplary embodiments of the invention access to parking spots through the reservation system is controlled by rules. Each rule includes one or more rule attributes. In some embodiments a single rule includes 2, 3, 4, or 5 or more attributes. Alternatively or additionally, in some embodiments multiple rules are applied to a given parking spot. Exemplary rule attributes include, but are not limited to spot ownership type, temporal limitations (for example, days and/or hours during which the rule applies); user type limitations (for example, residents only), duration limitations (for example, maximum stay of 0.5, 1, 2 or 3 hours), and legal status. In some embodiments rules include an hourly payment rate for the spot. In some embodiments there are group rules, such as of the 100 spots in this area 5 spots must always be available for handicap vehicles.

Exemplary Rule Application Schemes

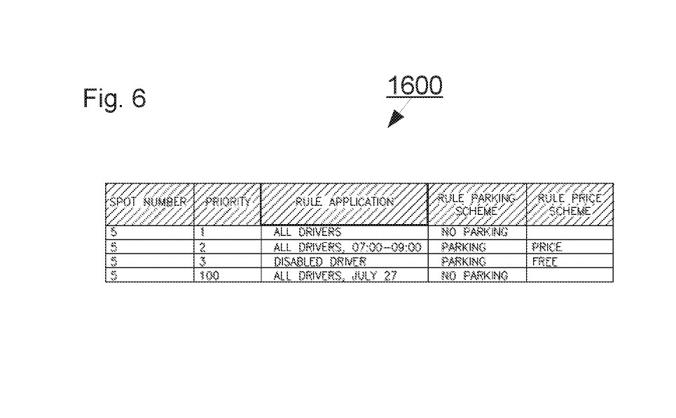

In some embodiments rules are applied in layers, with a highest layer number governing. FIG. 6 is a table, indicated generally as 1600 illustrating an exemplary rule application scheme according to some embodiments of the invention.

In the depicted embodiment a single spot number (5) is depicted in the leftmost column for clarity although the system is capable of applying rules, or changes to rule, to large numbers of spots concurrently.

In the depicted embodiment second column from the left indicates priority or layer. According to this embodiment the highest priority, or top layer, governs lower priorities or layers for spot(s) indicated in the leftmost column.

The middle column indicates rule attributes. Again the rules presented here are simplified for clarity although a single rule can be defined in a large number of attributes as explained in “Exemplary rule attributes: hereinabove”.

The second column from the right indicates parking scheme in terms of parking/no parking for vehicles and potential parking events matching all the attributes of the rule in the highest priority applicable layer.

The rightmost parking indicates price scheme in terms of free or fixed price for vehicles and potential parking events matching all the attributes of the rule in highest priority applicable layer.

Alternatively or additionally, in some embodiments the base layer excludes all vehicles at all times. According to these embodiments, each successive layer adds permissions. In some embodiments permissions are described in terms of rule attributes as detailed hereinabove and/or in terms of additional attributes and/or in terms of combinations of 2, 3, 4 or 5 or more attributes.

Elevation Considerations

In order to facilitate navigation to a specific spot in a multistory garage, elevation coordinates are used in some embodiments. Alternatively or additionally, in some embodiments a UI displays level row and spot number on the display when the vehicle approaches the garage. Use of such a UI is advantageous in situations where tracking devices used in many smartphones do not function well, such as underground facilities.

Parking Lots/Garages

In terms of rulemaking considerations, some lots/garages are permitted to rent out spots, or blocks of spots, independently of the system in some embodiments. For example, garages accustomed to leasing blocks of spots to companies in an adjacent office building are unlikely to surrender this revenue stream in order to participate in the system. In such cases the garage operator uses lot spot manager 153 (FIG. 1) to enter rules in rule and spot manager 150 (FIG. 1 indicating that the leased spots are either unavailable to any car at any time or are reserved for a specific vehicle identification number for the entire term of the lease. According to various exemplary embodiments of the invention rule making for spots within a parking lot or garage remains in the hands of owners (for example, for price determination) and/or be relegated to city control (for example, for traffic control purposes or load balancing). In some embodiments different levels of priority for spaces in a lot/garage are given to owner and city.

Exemplary Pavement Marking Considerations.

In some exemplary embodiments of the invention, pavement markings correspond to the UID assigned to a specific spot in spot DB 164. In other exemplary embodiments of the invention, shorter alphanumeric indicators, such as a 2 or a 3 digit numeral and/or a single letter or two letter combination serve as pavement markings.

According to these embodiments, a relevant pavement marking is associated with each UID in spot DB 164 together with the location coordinates of the spot.

Although the same pavement marking may be used many times within an area under administration of system 100 (FIG. 1) confusion is unlikely so long as sufficient location information (such as a printed map or navigation instructions) is provided to each user client device that reserves a parking spot. In some embodiments a “pavement marking” is applied to a sidewalk, curb, adjacent wall or sign instead of to a road surface.

Exemplary User Profile Considerations

According to various exemplary embodiments of the invention user profiles are stored within system 100 (for example as part of Vehicle DB 162) and/or on user client devices 122.

Alternatively or additionally, according to various exemplary embodiments of the invention user profiles are compiled and maintained by a user and/or are assembled by system 100 (for example from event history DB 168).

For user profiles compiled and maintained by a user, a user interface is provide, for example via an application installed on a user client device or via an Internet portal. In some embodiments the user interface employs a username and/or password

In some embodiments a user interface for user profiles compiled and maintained by a user includes fields such as, for example “my vehicles” and/or “my devices” and/or “my destinations” and/or settings.

In some embodiments “my vehicles” includes a field for entry of one or more vehicle registration numbers.

In some embodiments “my devices” includes a field for one or more telephone numbers (mobile and/or VOIP and/or PSTN based numbers)

In some embodiments settings includes input options for user preferences. For example, radio buttons for “auto-select lowest price”, “auto-select closest spot to destination” and “show me options”. As an additional example radio buttons for “auto-select indoor spot if available”, “auto-select indoor spot if closest to destination” and “ask me every time if an indoor spot is required”. As an additional example, in some embodiments the settings portion of the user interface contains input options for auto-select first item in list after 0, 5, 10, 15, 30 or 60 seconds or intermediate or greater times. As an additional example, in some embodiments the settings portion of the user interface contains input options for maximum hourly rate. Alternatively or additionally, in some embodiments “my destinations” includes input fields for home and work locations and/or user selected locations.

Alternatively or additionally, in some embodiments system 100 populates the “my destinations settings” using recent parking events in event history DB 168 associated with the user via a user client device 122 and/or one or more vehicle registration numbers.

Exemplary Advantages

Systems and methods described hereinabove contributes to a reduction in maintenance of physical infrastructure (for example, parking meters and/or parking regulation signs and/or access gate), as drivers are directed to a parking spot based on a GUI as exemplified in FIG. 7b.

Alternatively or additionally, systems and methods described hereinabove contribute to a reduction in supervision requirements (personnel and/or vehicles), for example, by use of violation system 130 in FIG. 1.

Alternatively or additionally, systems and methods described hereinabove contribute to a reduction in over-payments and under-payments relative to parking meters, for example, by using history DB 168 in FIG. 1.

Alternatively or additionally, systems and methods described hereinabove contribute to increased utilization of both public and private parking resources and/or to increased flexibility in managing parking resources as a whole and/or individual parking spots by use of a method for customizing parking spots to size of vehicle as exemplified in FIG. 4.

Alternatively or additionally, systems and methods described hereinabove enable advance reservation of a specific spot even in on-street parking situations.

Alternatively or additionally, systems and methods described hereinabove do not require sensors installed in spots, although they are amenable to use in the context of sensor based systems.

Various embodiments of system 100 described hereinabove provide control over previously un-monitored parking spots, such as no-cost parking. System 100 manages previously un-regulated no-cost parking spots and can enforce regulations (e.g. parking duration time limits). In some embodiments enforcement of regulations on no-cost spots contributes to greater availability of these spots. Mapping and reservation of no-cost spots is as described hereinabove. This is done as shown and described above by mapping the no-cost parking spots and adding them to spot database 164 like any other spot. In some embodiments this additional regulation contributes to a public perception of increased parking availability.

Exemplary Network Communications

According to various exemplary embodiments of the invention data is transmitted across a network. According to various exemplary embodiments of the invention the networks include the internet and/or local area networks (for example, at a command and control center) and/or cellular communications networks (voice and/or data) and/or the public switched telephone network (PSTN).

First Exemplary Use Scenario

In many cases the regional authority is aware of the date of a special event which will disrupt traffic, weeks or even months ahead of the event. More specific details of the event and of the specific areas to be affected may not be known until much closer to the event.

Referring again to FIG. 1, CCC 151 prevents all parking reservations of the date of the event in the affected region well in advance. This “blackout” status is imposed by implementing a rule in rule and spot manager 150 with “all drivers” and the date of the event” as attributes, “no parking” as the scheme assigning it the maximum priority (for example, 100) and applying it to all the spots in the affected region, in DB 164. As the event grows closer and planning details grow clearer, the blackout rule for the whole region can be gradually replaced by a set of rules which are geographically more specific and less exclusive to users wishing to park on the day of the event.

Where relevant, notices are sent to users (for example, subscribers and/or residents) informing them that their parking rights will be suspended for the day of the event.

Second Exemplary Use Scenario

Delivery trucks typically require oversized spots for short periods of time, for example, to load or unload merchandise. The oversized spots are typically required along known routes, at known locations and/or at a known schedule. To date, trucks stopping to load or unload typically extend into the street causing slowdown of cars and traffic congestion.

Referring to FIGS. 1 and 3, in some embodiments a truck registration number is entered through user client device 122 and the truck registration number is transmitted from the parking reservation server 120 to vehicle registration DB 162 as exemplified in flowchart 1300. In some embodiments the location of the truck may is known (e.g., based on GPS tracking of the user client device used for entering the truck registration number). Thus, based on location of the truck (e.g., when the location of the truck is proximate to a known loading or unloading location), at predetermined dates and/or hours during the day a pre-set additional size requirement is automatically employed 1355 for the truck registration number, resulting in calculation of an appropriately sized parking spot 1330 and automatic reservation 1340 of the spot, typically for a limited predetermined time period.

This feature enabled by methods and systems according to embodiments of the invention allows for suitable parking spots for trucks thereby contributing to a reduction in eliminating traffic congestion.

Third Exemplary Use Scenario

Referring now to FIG. 7c, in some embodiments business places want to reserve large enough parking spots near the business place for delivery trucks. According to these embodiments the owner of the store or other business subscribes to several contiguous parking sub units at the front of the store, for example, sub units 1730, 1731 and 1732, for certain days and for certain time slots on those days.

Fourth Exemplary Use Scenario

Venues such as sport stadiums typically have large parking areas which are filled to capacity during a sports event at the stadium but which are relatively empty at other times.

In some embodiments in order to provide more efficient utilization of a venue parking area, CCC 151 (FIG. 1) applies a rule of low rates or even free parking to all parking spots (or parking subunits) in the stadium area when there is no event in the stadium. In another embodiment the venue parking area is, when there is no sports event, as a park & ride area (transportation hub) with shuttles running from the parking area to a regional or city center. According to these embodiments, a parking spot in the venue parking area is suggested to drivers on the UI of user client device 122 in response to a user entering a destination in the city center.

During an event or typically a predetermined time prior to the event a rule change is applied to all spots in the stadium parking area through rule DB 166. According to various exemplary embodiments of the invention the rule change includes an increase in price and/or a limit on allowed parking duration. Alternatively or additionally, system 100 offers a discount for advance reservations for event parking, which reservations are stored at spot DB 164.

Exemplary Enforcement Considerations

Although many users might normally be reticent to inform on a vehicle that is guilty of a parking violation, system 100 encourages, or even requires, them to do so if an unauthorized vehicle is parked in a spot reserved for them. Spot reservation gives a sense of entitlement which makes reporting a violation seem more acceptable. Alternatively or additionally, if an unauthorized vehicle is parked in a spot reserved for a user, the user needs to report the event to the system in order to receive an alternate spot.

In some embodiments a user client device 122 is operated by a warden, for example, an officer of the municipality. The UI of a user client device 122 used by a warden may typically include a map or other representation of a region showing available and non-available parking spots or subunits. A warden may be referred to specific parking spots through violation system 130 and/or the warden may identify violations by comparing the map on his user client device 122 to the actual situation on-site.

Exemplary Backup Considerations

In some exemplary embodiments of the invention, for example when system 100 is applied to a region such as a municipality which is transitioning from a current or default status in which municipal parking rules are posted on signs or painted on pavements and/or curbs the computerized system of FIG. 1 overrides the previously installed visual instructions, so long as the system is functioning. In some embodiments as long as the various communications networks of system 100 are in working order, then the only way to legally park in the city is through system 100.

In case of a failure of system 100, or a component communications networks, or other operational component, predetermined default parking rules are available to all.

For example, signs and painted markings may apply when the system is down (This is analogous to a stop sign at an intersection with a traffic light; the stop sign is in position for times when the traffic light does not function).

Alternatively or additionally, system 100 includes a backup database storing the city's “default” settings for each parking spot in a downfall situation. In some embodiments “default” settings are available for download to a user client device for future use. Alternatively or in addition printed maps of the city's “default” settings may be posted on billboards, or in the printed or electronic media, and the like.

After the system is back “up” a grace period is permitted in which cars that parked according to the default settings are not ticketed.

Additional Exemplary Considerations

In some embodiments system 100 includes a queue management module managing (DB 172 in FIG. 1) a queue of parking requests. In some embodiments parking requests are prioritized based on different parameters as described herein. In one embodiment parking requests are prioritized based on a user's (e.g., driver's) reputation. In some embodiments a driver's reputation is saved as part of a user profile. For example, in some embodiments a driver (represented by their user client device, e.g., UCD 122a) that repeatedly violates is given negative points by the queue management module whereas drivers that abide by the rules are given positive points. Alternatively or additionally, in some embodiments a driver's reputation is based on the amount of positive and negative points accumulated in the queue management module. In one embodiment a user's reputation is used to change the priority of a parking request in a queue, e.g., to offer better conditions (e.g., less waiting time) to a driver having more positive points and/or offer worse conditions to a driver having more negative points.

In some embodiments a warden is given a suggested route to check for violations using a map provided to the warden from CCC 151 (FIG. 1). In some embodiments system 100 adjusts itself to “add” notifications when additional violations occur along the route and/or generate new routes which incorporate newly registered violations. In some embodiments, this feature contributes to an increase in the number of citations/unit time from a single warden.

In some embodiments a method, includes providing suggested routes to a warden, e.g., the most efficient route for the warden to walk (or otherwise travel) to a parking spot of interest. Parking spots of interest include, for example, parking spots due to expire in 5; 10; 15 or 20 minutes or smaller or intermediate periods of time and/or parking spots where a violation has been reported and/or other parking spots where a warden's checkup is desired.

Alternatively or additionally, in some embodiments the suggested route is based on a known location of the warden (e.g., based on the GPS location of the warden's user client device and/or based on known locations of parking spots of interest.

In some exemplary embodiments of the invention, a warden is assisted by camera based or other sensors located and positioned along streets and other parking areas to monitor parking spots (e.g., by detecting and recording vehicle license plate numbers using OCR technology). In some embodiments a warden uses the information provided by the camera and/or sensors to report status changes of parking spots and/or violations. Alternatively or additionally, in some embodiments a route is suggested to the warden (as described above) based on the information provided by the sensors. In some embodiments the suggested route is based on a known location of the warden (e.g., based on the GPS location of the warden's user client device and/or based on known locations of parking spots of interest.

In some embodiments a status of specific parking spots is updated in DB 164 (e.g., from “occupied” to “available”) based on reports from user client devices (such as devices 122a or a warden's device). In some embodiments the status of specific parking spots is updated in DB 164 based on input from a sensor located and positioned along streets and other parking areas to allow monitoring of parking spots. According to various exemplary embodiments of the invention the sensors include cameras and/or RFID tags located at each parking spot or parking subunit. For example, in some embodiments RFID tags are integrated into pavements or roads at each parking subunit. According to these embodiments, RF readers in vehicles allow system 100 (FIG. 1) to identify vehicles (specifically which vehicles) that have entered or exited specific parking spots. Alternately RFID tags are located in vehicles and RF readers are located at parking spots.

In some embodiments method 3700 includes receiving 3740 a confirmation of parking in a reserved spot and/or of exiting a reserved spot based on input from a sensor monitoring the spot, such as an RFID sensor capable of communication with the system.

In some embodiments parcels of land or parking subunits are marked by painted markings (such as lines demarcating each parking subunit) on pavements or roads. Alternatively or additionally, in some embodiments other markings are used (e.g., in geographical regions suffering from harsh weather such as snow and fog), such as sign posts or other appropriate techniques.

In some embodiments, in order to facilitate identification of a parking spot, numbers or other identifying characters are placed adjacent to the end of the lines demarcating each parking subunit. Sidedness may be indicated for example by the addition of “L” or “R” to the identifying characters, based on which side of the road the parking spot is located. In some embodiments each marking has an adjacent color painted (or otherwise applied) on the pavement/street. In some embodiments the colors appear in a fixed sequence (eg. RGB—Red, Green Blue). Alternatively or additionally, in some embodiments each identifying character (or group of characters) has a corresponding color thereby making it easier to identify a parking spot (e.g., trying to identify a spot composed of subunit 244 Green or 42 Blue). Alternatively or additionally, in some embodiments different sided sidewalks are painted in a different color or numbered (e.g., odd/even), facilitating identification of parking spots.

In some embodiments privately owned spots, or other off-street parking subunits are marked with similar markings as on-street parking subunits to facilitate identification of all parking spots within system (e.g. system 100).

According to some embodiments of the invention privately owned spots, or other off-street parking subunits or spots are included in system 100, thereby enabling enforcement (e.g., by wardens) and other advantages of the system in privately owned and other off-street parking spots for the benefit of the off-street parking spot owners.

Alternatively or additionally, in some embodiments system 100 is backed up by mirroring servers and/or DBs in different location. If one of the servers crashes, incoming communications from UCDs 122 are directed to the mirror.

In some embodiments, in case of failure or shutdown of the entire system including backups a procedure is initiated in which user client devices 122 are notified and are requested to manually switch or are automatically switched to off-line mode. According to these embodiments, off-line mode devices receive parking rules and/or a driver parks using default parking rules. In some cases additional features are provided. Additional features in this context include, but are not limited to billboards advising drivers of parking rules during system failure.

In some embodiments drivers continue to report arrival at a reserved parking spot and/or exit from the parking spot in offline mode. According to these embodiments offline mode reports are stored on the user client devices 122. Once system 100 is back up, reports stored in user client devices 122 are uploaded to system 100 and server 120 updates event history DB 168 with offline mode parking events. In some cases, by statistically analyzing the events (based on history analytics), the system determines how many events should have occurred and also how many were reported, thereby deriving the percent of “unreported” events. In some embodiments the unreported events are accommodated by increasing an occupancy buffer to handle larger margins of error (e.g., if it is determined that only 80% of the actual parking events were reported, 20% extra free spaces can be left open to allow reallocation for people requesting spots that were occupied).

In some embodiments in case of failure of data networks providing communication between UCDs 122 and server 120 (which may effect for example 3G based user client devices), users park using unaffected functions of their devices, such as by using SMS messaging and/or Interactive voice response (IVR) and/or unaffected devices such as a kiosk or devices at call centers.

Alternatively or additionally, in some embodiments in case of failure of phone networks drivers park using devices such as a kiosk or warden's devices.

Alternatively or additionally, in some embodiments basic vehicle details such as size and color may are pre-stored on user client device 122 to be used in case of failure of a DB at an external licensing authority from which vehicle DB 162 receives information regarding vehicle attributes. In some embodiments vehicles parking for the first time during failure of an external licensing authority DB are required to enter one or more details (e.g., by choosing a vehicle size from a list of several, e.g., 3 size categories and color from a list of colors) in order to reserve parking via system 100.

Alternatively or additionally, in some embodiments in case of failure of a navigation system associated with a user client device 122, a driver uses maps available from a kiosk or another navigating systems or is directed by an operator at a call center.

Alternatively or additionally, in some embodiments in case of failure of payment methods operated by user client device 122, payment is achieved by other methods such as by paying at a kiosk or by mail.

Exemplary Subunit Assembly Strategies

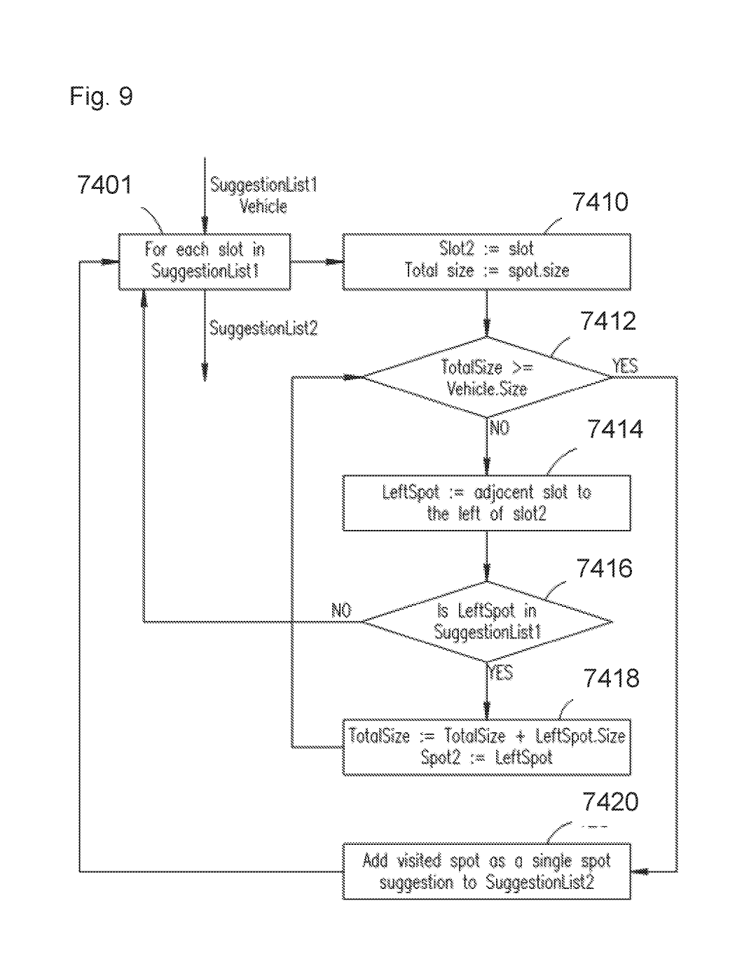

FIG. 9 is an exemplary flow chart illustrating operation of a parking spot management system, according to some embodiments of the invention.

In some embodiments system 100 stores a size attribute of the vehicle, which may list how many parking subunits (also referred to as slots) the specific vehicle requires, and a slot record may list the adjacent component parking slot(s) to the current component parking slot. In one embodiment, only one adjacent component slot, the one to the left, for example, of the current component slot, is stored.

FIG. 9 illustrates a BuildSizeAwareList function, given a suggestion list SuggestionList1 of possible component slots and vehicle information, to determine if a group of neighboring slots is available to a current component slot. Suggestion list builder 110 may loop (step 7401) on each component slot in the SuggestionList and may, in step 7410, initially set a COMPONENT SLOT2 variable to the current component slot and a TOTALSIZE variable to the size of the current component slot. In step 7412, a check is made whether the current TOTALSIZE is larger than the vehicle size. If it is not, a loop is entered which will continue until the check is positive. When the TOTALSIZE is smaller than the vehicle size, such as will happen if the component slots are generally smaller than the vehicles, a LEFTCOMPONENT SLOT variable will be set (step 7414) to the adjacent component slot of the COMPONENT SLOT2 component slot, which, as described hereinabove, is to the left of the COMPONENT SLOT2 component slot.

As checked in step 7416, if the LEFTCOMPONENT SLOT is not in SuggestionList1 (i.e. it was not available when SuggestionList1 was made) or if it is Null, then the loop returns to step 7401 for the next component slot. Otherwise (i.e. the LEFTCOMPONENT SLOT is not Null and is in SuggestionLisa), then, in step 7418, its size of LeftComponent slot is added to TOTALSIZE and LeftComponent slot becomes the new COMPONENT SLOT2. The loop returns to step 7412 to see if the current TOTALSIZE is larger than the vehicle size.

The process may continue the loop until TOTALSIZE is larger than the vehicle size (i.e. the sum of the sizes of the adjacent component slots in SuggestionList from the initial component slot is larger than the vehicle size). For example, if the vehicle size is slightly smaller than 2 small component slots, the loop will have repeated once before TOTALSIZE was larger than the vehicle size. If the vehicle size is slightly smaller than 3 small component slots, the loop will have repeated twice before TOTALSIZE was larger than the vehicle size.

Once the loop has finished, in step 7420, the visited component slots may be added, as a single dynamic spot, to a new list, Suggestion List2. The single dynamic spot may be defined in any suitable way, such as by the first spot in the list.

The operations of FIG. 9 may find groups of slots that are currently available. However, these slots may be allocated inefficiently and may leave many small component slots unused.

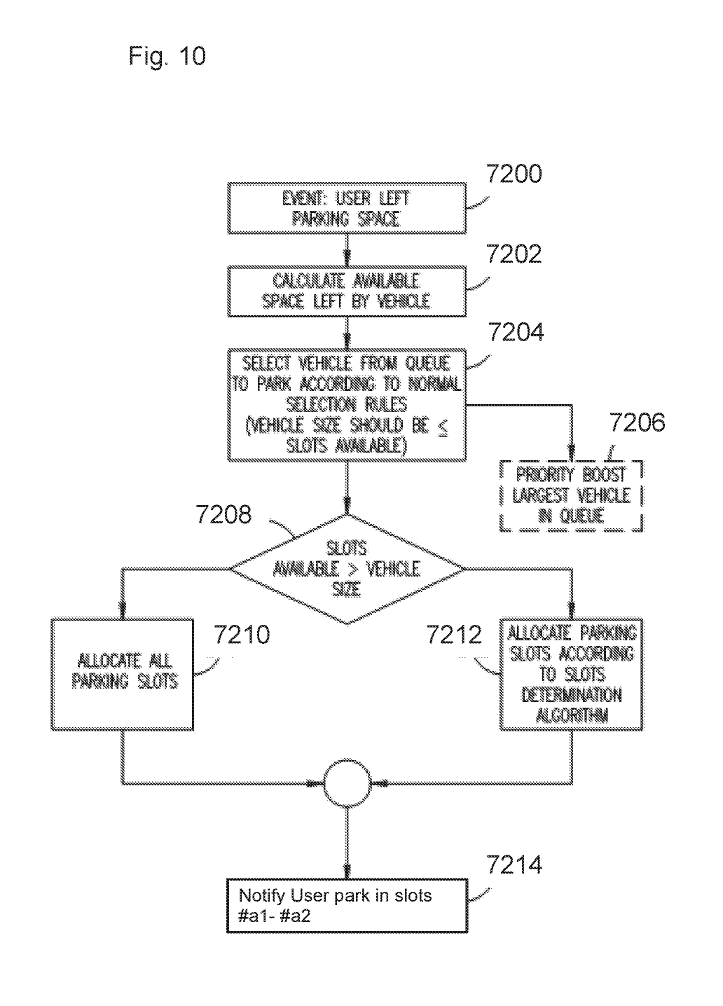

Reference is now made to FIG. 10 which is an exemplary flow chart of a method to increase the efficient use of the component slots, according to an embodiment of the present invention. Operation of the parking space management system may include implementing best-fit or other suitable allocation algorithms, and which may include fragmentation and defragmentation algorithms.

At 7200, a user in a vehicle occupying a dynamic parking spot composed of several component parking subunits (also referred to as slots) may notify the parking spot management system of his intended departure, and following the notification, may depart.

At 7202, the parking spot management system looks for contiguous component parking slots. It determines the number of component parking slots vacated by the departed vehicle and calculates the number of available component slots adjacently located to the recently vacated component slots.

At 7204, the parking spot management system selects a vehicle from its queue of vehicles seeking a parking spot in a region or in the vicinity of the region. The selection rules for the vehicle may vary according to the automated parking spot allocation system being used but should include information regarding the size of the vehicle, such as the number of component parking slots the vehicle requires, in order to determine if the vehicle fit into the available and contiguous component parking slots. If not, the vehicle is rejected and a new vehicle is selected from the queue.

At 7206, as an optional step, the parking spot management system may give priority to a specific vehicle requesting a parking spot in a region or in the area of the region. For example, if not all vehicles can be accommodated in the available component parking slots, dynamic parking spots will be evaluated and assigned in order of priority and/or vehicles which fit the available dynamic parking spots may be assigned the slots irrespective of the priority they have. The rules for determining priority may vary according to the automated parking spot allocation system used.

At 7208, the parking spot management system determines all combinations of available and contiguous component parking slots that can accommodate the size of the vehicle selected from the queue. The parking spot management system may then decide on an allocation method to use, a known allocation method at 7210, or a defragmentation method at 7212.

At 7210, the parking spot management system may use the known allocation method which may include the execution of a best fit allocation algorithm or other known allocation method, including fragmentation methods, to allocate a spot to the selected vehicle. The known allocation method may attempt to fit all vehicles into any parking spot within all available and contiguous component parking slots whose combined size is the same or larger than the vehicle size. The known allocation method may also take into consideration conditions associated with the selection rules of the automated parking spot allocation system.

At 7212, alternatively to the known allocation method, the parking spot management system may use the defragmentation method to allocate spot to the selected vehicle.

At 7214, the user is notified that there is a parking spot in a region, and the identity of the component slots forming the dynamic spot allocated to the vehicle. The method of notification may vary according to the automated parking spot allocation system being used.

When used in combination with a list or database of reservation requests and/or with a database of analytics of traffic of parking cars, these and other algorithms and methods of allocation may be used to further optimize utilization of the parking area.

It is expected that during the life of this patent many new types of user client devices and/or communications networks will be developed and the scope of the invention is intended to include all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as separate items/individual actions may be combined into a single item/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Specifically, the invention has been described in the context of parking but might also be used as a traffic control system.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1. A method comprising:
(a) transmitting a vehicle registration number from a parking reservation server to a vehicle registration database;
(b) receiving vehicle dimensions at said parking reservation server in response to said transmitting;
(c) calculating a parking spot size based on said vehicle dimensions; and
(d) reserving an appropriately sized parking spot based on results of said calculating.

2. A method according to claim 1, comprising:
receiving at said parking reservation server additional size requirements and employing said additional size requirements in said calculating.

3. A method according to claim 1, comprising:
accessing reservation history for the vehicle registration number; and
transmitting a query concerning additional size requirements to a user client device if a recent reservation from the same vehicle registration number included additional size requirements.

4. A method according to claim 1, comprising:
assembling two or more contiguous spots to create said appropriately sized parking spot.

5. A method comprising:
(a) storing a list of parking subunits at a parking reservation server, each parking subunit associated with a unique identifier (UID) and location coordinates;
(b) receiving a parking reservation request including a vehicle registration number at said server from a user client device;
(c) ascertaining a size of said vehicle from said vehicle registration number.
(d) assembling a parking spot sized for said vehicle from two or more contiguous parking subunits; and
(e) transmitting location coordinates of said parking spot sized for said vehicle to said user client device as part of a reservation confirmation.

6. A method according to claim 5, comprising associating said location coordinates of said parking spot sized for said vehicle with instructions to launch a navigation program on said user client device.

7. A method according to claim 5, wherein all of said parking subunits are same sized.

8. A method according to claim 5, wherein said parking subunits include at parking subunits that are differently sized.

9. A method comprising:
transmitting a parking request including a vehicle registration number and a destination to a reservation server from a user client device;
receiving at said user client device a response comprising:
a map of an area in proximity to said destination with available parking subunits indicated; and
a rectangle representing the vehicle defined by said registration number according to a scale of said map; and
positioning said rectangle over two or more contiguous available subunits and entering a confirm command to reserve said two or more contiguous subunits.

10. A method according to claim 9, wherein said subunits are part of a parallel parking arrangement.

11. A method according to claim 9, wherein said subunits are part of a non-parallel parking arrangement.

12. A method according to claim 9, comprising increasing a length and/or width of said rectangle to cover additional subunits.

13. A system comprising:
parcels of land each having a unique identifier;
a database of said parcels of land; and
a processor to calculate a parking spot using said parcels of land.
